(19) United States
(12) Patent Application Publication
(10) Pub. No.: US 2021/0108758 A1
(43) Pub. Date: Apr. 15, 2021

(54) ADJUSTABLE MANIFOLD STAND AND SYSTEM

(71) Applicant: MidCentral Equipment Services LLC, Oklahoma City, OK (US)

(72) Inventor: Justin Loven, Lubbock, TX (US)

(73) Assignee: MidCentral Equipment Services LLC, Oklahoma City, OK (US)

(21) Appl. No.: 17/068,299

(22) Filed: Oct. 12, 2020

Related U.S. Application Data
(60) Provisional application No. 62/913,368, filed on Oct. 10, 2019.

(51) Int. Cl. F16M 11/32; E21B 19/15; F16L 3/10

(52) U.S. Cl. CPC F16M 11/32; F16M 2200/08; F16L 3/10; E21B 19/15

(57) ABSTRACT

An adjustable stand that can by employed in a hydraulic fracturing system is disclosed herein. The adjustable stand preferably includes a frame, legs, clamps and a rack. The legs are connected to and support the frame. The racks are connected to the frame and extend upward from the frame and the clamps are mounted onto the racks. The legs are configured to raise and lower the frame, and the clamps are configured to be raised and lowered on the rack. The ability of the legs and the clamps to be adjusted allows the stand to be modified to support various objects and be modified to accommodate various systems.

### CROSS REFERENCE TO RELATED APPLICATIONS

This application claims the benefit of U.S. Provisional Patent Application Ser. No. 62/913,368 entitled ADJUSTABLE MANIFOLD STAND AND SYSTEM filed on Oct. 10, 2019, and incorporates said provisional application by reference in its entirety into this document as if fully set out at this point.

### FIELD OF THE INVENTION

The present invention generally relates to products and systems used in the oil and gas industry and more particularly, but not by way of limitation, to products and systems configured for hydraulic fracturing.

### BACKGROUND OF THE INVENTION

Hydraulic fracturing systems feature a large number of pipes connected to a central manifold. The fracturing systems are built to be used at multiple well sites and therefore are generally constructed in a manner adaptable to various site structures. A manifold system generally incorporates small diameter flexible piping that can be moved and adjusted to accommodate varying well sites and fracturing jobs. Although useful for quick adjustments, the small diameter flexible pipe is more vulnerable to wear and tear. Often, the small diameter pipe is connected to the pumping system and is placed on the ground and crosses over other pipes at the well site. Small diameter pipe also requires a higher internal fluid flow rate to perform hydraulic fracturing. Higher levels of fluid flow rate equates to increased wear and tear. Larger pipe suited for higher flow rates is more durable and able to withstand the higher flow rates for hydraulic fracturing. However, larger diameter pipe is more difficult to adjust to ensure an efficient flow rate as needed during hydraulic fracturing. There is, therefore, a need for an improved product and system that overcomes the deficiencies in the prior art.

### SUMMARY OF THE INVENTION

In general, the invention relates to an apparatus and system for adjustable stands which can be used as support members. These support members may include an adjustable stand that can by employed in a hydraulic fracturing system. The adjustable stand includes a frame, legs, clamps and a rack. The legs of the adjustable stand are connected to and support the frame. The rack is connected to the frame and extends upward from the frame. The clamps are mounted onto the racks. The legs are configured to raise and lower the frame and the clamps are configured to be raised and lowered on the rack. The ability of the legs and the clamps to be adjusted allows the stand to be modified to support various objects and be modified to accommodate various systems.

The foregoing has outlined in broad terms some of the more important features of the invention disclosed herein so that the detailed description that follows may be more clearly understood, and so that the contribution of the named inventors to the art may be better appreciated. The invention is not to be limited in its application to the details of the construction and to the arrangements of the components set forth in the following description or illustrated in the drawings. Rather, the invention is capable of other embodiments and of being practiced and carried out in various other ways not specifically enumerated herein. Finally, it should be understood that the phraseology and terminology employed herein are for the purpose of description and should not be regarded as limiting, unless the specification specifically so limits the invention.

### BRIEF DESCRIPTION OF THE DRAWINGS

FIG. 1 is a perspective view of an adjustable stand in accordance with exemplary embodiments.

FIG. 2 is a perspective view of another embodiment of an adjustable stand in accordance with exemplary embodiments.

FIG. 3 is a side view of the adjustable stand of FIG. 2.

FIG. 4 is a perspective view of another embodiment of an adjustable stand in accordance with exemplary embodiments.

FIG. 5 a system of hydraulic fracturing pipes supported by adjustable stands.

FIG. 6 a system of hydraulic fracturing pipes supported by adjustable stands.

FIG. 7 is a high flow hydraulic fracturing system incorporating adjustable stands.

### WRITTEN DESCRIPTION

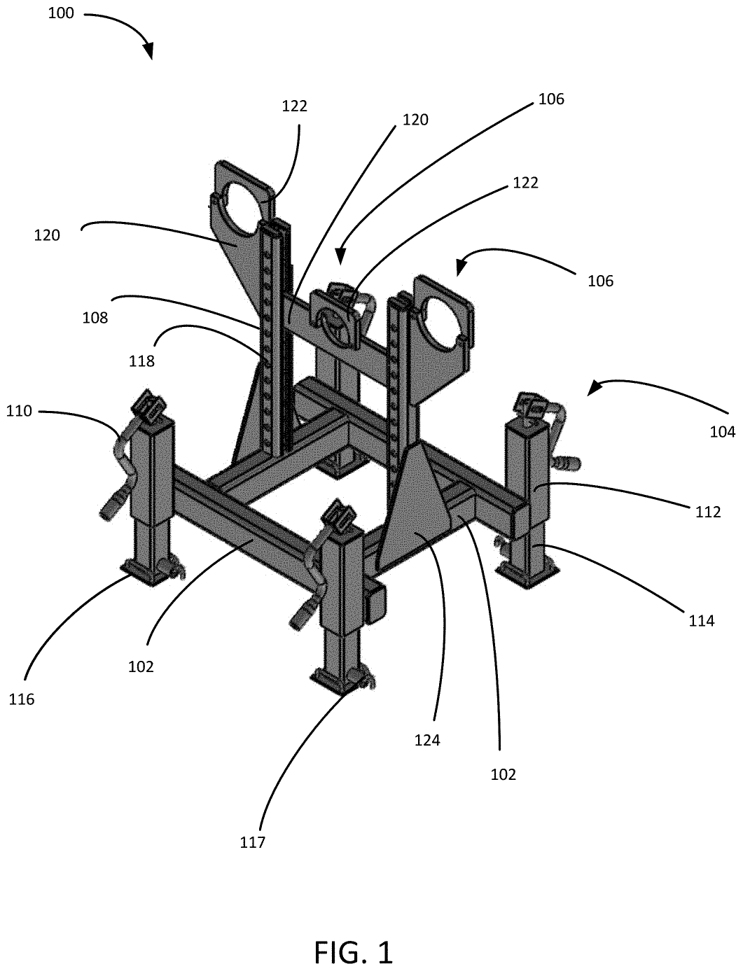

Referring first to FIG. 1, shown therein is a perspective view of an adjustable stand 100 constructed in accordance with a first embodiment. The adjustable stand 100 includes a frame 102, legs 104, clamps 106 and a rack 108. The legs 104 are connected to and support the frame 102. The racks 108 are connected to the frame and extend upward from the frame 102. The clamps 106 are mounted onto the racks 108.

The legs 104 are configured to adjust the height of the adjustable stand 100. The legs include a crank 110, telescoping sheath 112, support member 114, and foot 116. The foot 116 is connected to the support member 114 and provides a base for the leg 104. The foot 116 may also include an anchoring mechanism 117 which attaches the adjustable stand 100 to another surface. The anchoring mechanism 117 prevents movement of the stand 100 on a support surface. The anchoring mechanism 117 may comprise a stake, bolt, screw, vice, ties, or any other sufficient means of anchoring the foot. The support member 114 extends upwards from the foot 116 and is enveloped by the telescoping sheath 112. The telescoping sheath 112 can be raised or lowered on the support member 114 by turning the crank 110 which is connected to the telescoping sheath 112. In the present embodiment the telescoping sheath 112 is raised and lowered with a crank 110, however any other sufficient means of height adjustment such as a jack, pump, or an electrical lifting apparatus may be used.

The telescoping sheath 112 of the leg 104 is connected to the frame 102. The telescoping sheath 112 may be connected to the frame 102 with welds or any other sufficient connection. When the telescoping sheath 112 is raised or lowered the portion of the frame 102 to which the telescoping sheath 112 is connected is raised or lowered by the adjustment of the telescoping sheath 112. In the present embodiment the adjustable stand 100 is shown with four legs 104 which each have a crank 110. In other embodiments the stand may be shown with fewer or additional legs 104. The cranks 110 can be used individually to raise and lower different portions of the frame 102. In this manner the legs 104 provide a leveling system for the frame 102.

The rack 108 is connected to the frame 102 and extends upward from the frame 102. The connection between the frame 102 and the racks 108 may be supported by a flange 124 which overlaps the connection point between frame 102 and rack 108. In FIG. 1 two flanges 124 are shown attached to the exterior of the frame 102 and racks 108. The rack 108 includes clamp mounts 118 which are positioned along the rack to allow the clamps 106 to be moved up and down the rack 108. In the embodiment shown in FIG. 1 the clamps 106 are attached to the racks 108 via an internal mechanism within the racks 108. The attachment between the racks 108 and the clamps 106 allows the clamps 106 to be moved up or down on the racks 108 while a portion of the clamp 106 remains within the rack 108. In other embodiments the clamps 106 may be attached to the rack with an adjustable sheath, nuts and bolts, clamps, or other suitable adjustable means.

The clamps 106 have a clamp support 120 and a clamp lock 122. The clamps 106 are attached to clamp mounts 118 via the clamp supports 120. The clamp supports can be raised or lowered on the rack 108 to any of the clamp mounts 120 on the rack 108. The frame 102 can have one or more racks 108 attached to it. In FIG. 1 two racks 108 are shown attached to the frame 102. In FIG. 1 three clamps 106 are shown attached to the racks 108. One clamp 106 is mounted between the racks 108, with the clamp support 120 being attached to clamp mounts 118 on each rack 108. An additional clamp 106 is mounted on the outside of each of the racks 108.

In FIG. 1 a clamp lock 122 is removably attached to the clamp support 120. In other embodiments the clamp lock 122 may be attached to the clamp support 120 with a mechanism that allows the clamp 106 to opened and closed without removal of the clamp lock 122 such as a hinge. In FIG. 1 The clamp support 120 and clamp lock 122 are shaped such that when the clamp support 120 and clamp lock 122 are attached the two can secure a pipe or other object in place. When the clamp lock 122 is detached a pipe or other object may be placed in the clamp support 120. In the present embodiment the clamp support 120 and clamp lock 122 are shaped to secure a secure a cylindrical pipe, but the clamp 106 may be shaped to secure other objects.

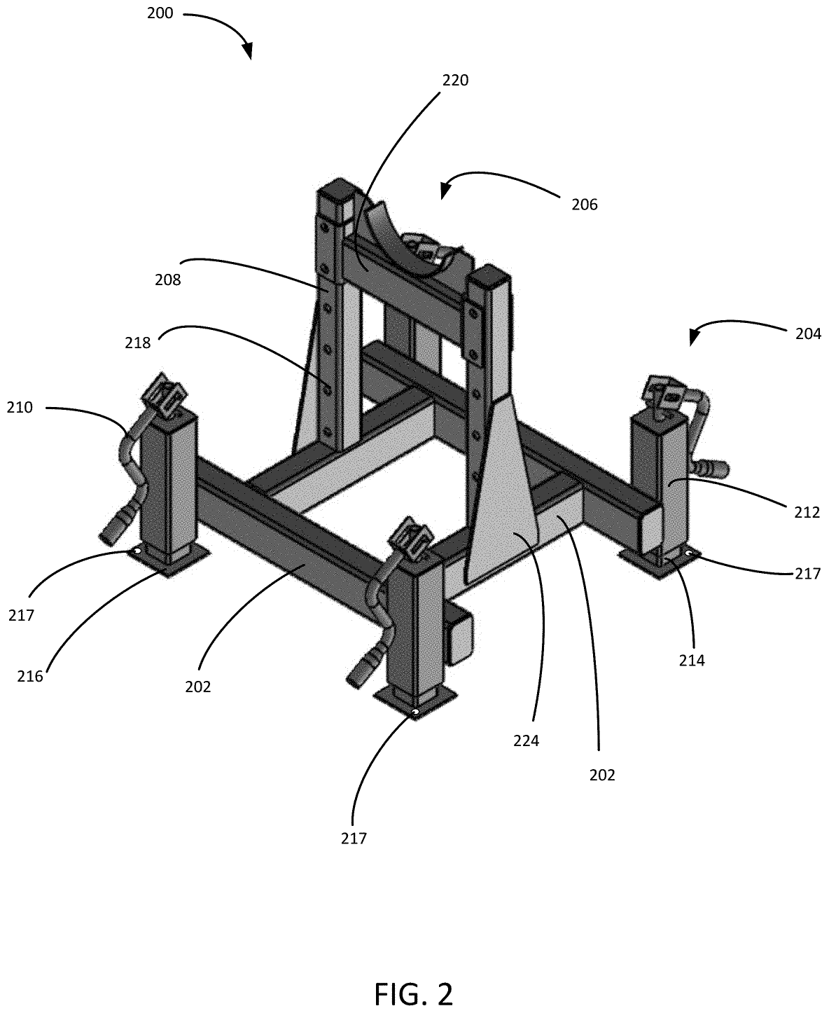

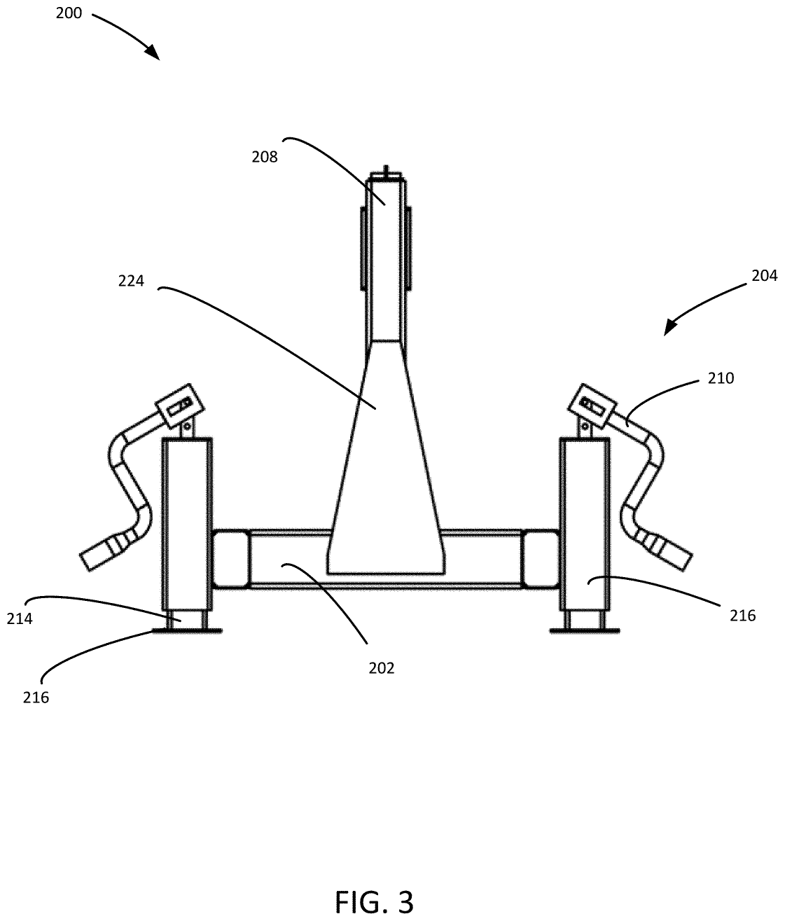

Turning now to FIGS. 2 and 3, another embodiment of the adjustable stand 200 is shown. The embodiment includes a frame 202, two racks 208, four legs 214, corresponding telescoping sheaths 212 and cranks 204, four feet 216 and an anchoring mechanism 217 on each foot 216, and one clamp 206. The rack 208 is connected to the frame 202 and extends upward from the frame 202. The connection between the frame 202 and the racks 208 is supported by a flange 224 which overlaps the connection point between frame and rack. In FIG. 2 two flanges 224 are shown attached to the exterior of the frame 202 and racks 206.

The rack 208 includes clamp mounts 218 which are positioned along the rack 208 to allow the clamps 206 to be moved up and down the rack 208. The clamp 206 shown is positioned between the racks 208. The clamp 206 is adjustably connected to each of the racks 208 via a partial sheath. The partial sheath of the clamp 206 extends around three sides of each of the racks 208. The clamp 206 is secured to the clamp counts 218 of the racks 208. In FIG. 2 each partial sheath of the clamp 206 covers two clamp mounts 218. Bolts, screws, fasteners or any other sufficient means may be used to secure the partial sheath of the clamp 206 to the clamp mounts 218. In FIG. 2 the clamp 206 consists only of a clamp support 220 which may support a pipe or other objects. In other embodiments additional clamps 206 may be attached to the racks 208 or a clamp lock 222 may be used in conjunction with the clamp support 220.

In FIG. 2 one clamp support 220 is shown attached to clamp mounts 218 between the racks 208. The clamp support 220 does not have a clamp lock 222 shown attached, but a clamp lock 222 may be attached to secure objects in the clamp support 220. The clamp support 220 is shown attached to two clamp mounts 218 on each rack 208. The use of additional clamp mounts 218 provides additional support to the clamp support 220. Additional clamp supports 220 with or without clamp locks 222 may also be attached to the racks 208.

In FIG. 3 a side view of the adjustable stand 100 of FIG. 2 is shown, demonstrating a level view of the adjustable stand 200. The telescoping sheaths 212 can also be extended and retracted to change the height of the adjustable stand 200 and an object within the clamps 206 without the need to remove the object placed in the clamps 206. The adjustable stand 200 can also be configured with legs 204 that may be raised or lowered jointly to provide a more even height adjustment to the frame 202.

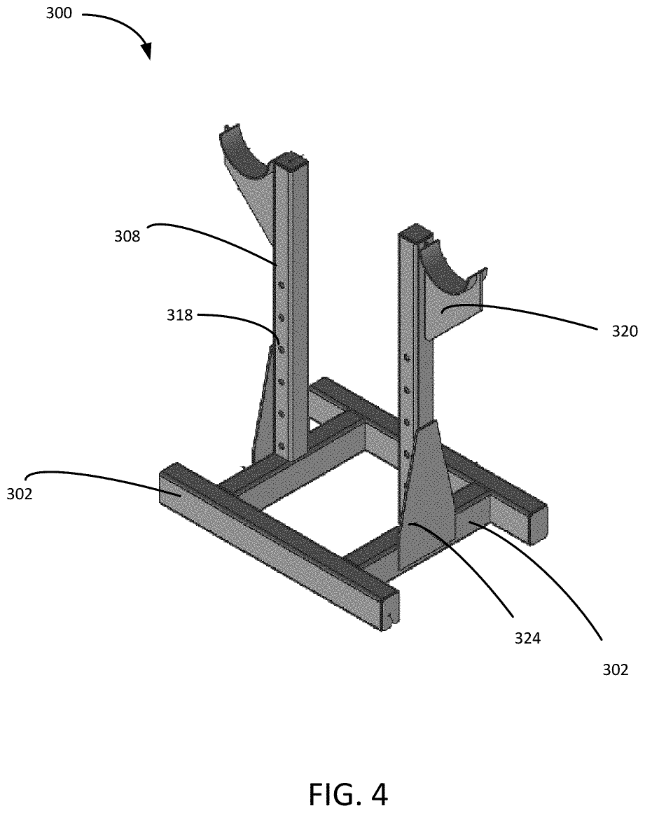

Turning now to FIG.4, another embodiment of the adjustable stand 300 is shown. The embodiment includes a frame 302, racks 308, and clamps 306. The rack 308 is connected to the frame 302 and extends upward from the frame 302. The connection between the frame 302 and the racks 308 may be supported by a flange 324 which overlaps the connection point between frame and rack. The rack 308 includes clamp mounts 318 which are positioned along the rack to allow the clamps 306 to be moved up and down the rack 308. The two clamps 306 shown are attached to the outsides of the racks 308. The clamps 306, which are attached to the clamp counts 318 of the racks 308, consist only of clamp supports 320 which may support pipe or other objects.

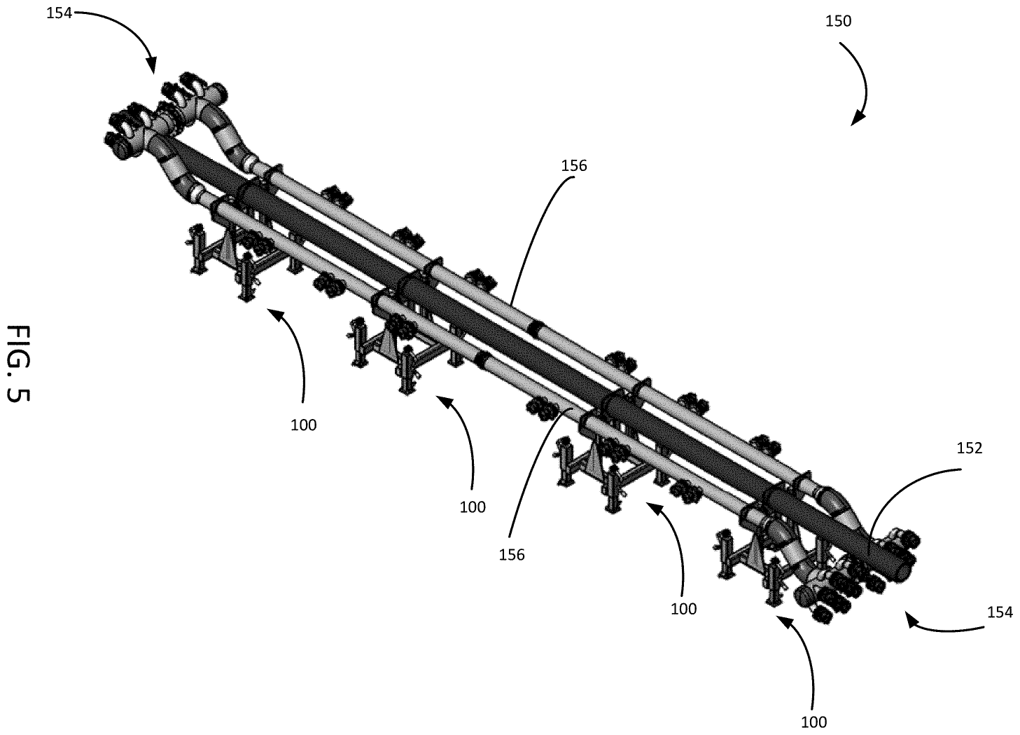

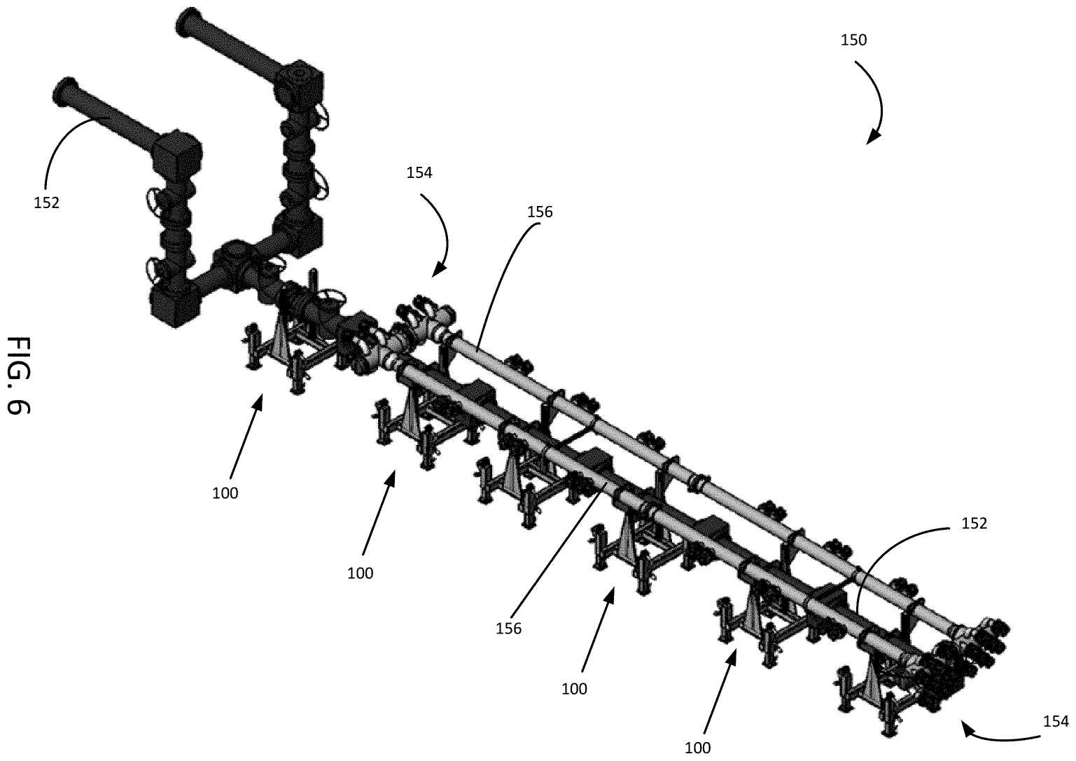

Turning now to FIGS. 5 and 6 a pipe system 150 is shown. In FIG. 5, the pipe system 150 includes a wellhead pipe 152, a manifold 154, manifold pipes 156, and four adjustable stands 100. In the pipe system 150 the adjustable stands 100 are used to change the height of the pipe system 150. It will be understood that adjustable stands 100, 200 or 300 may alternatively be used. The adjustable stands also provide support to the pipe system 150 and level the wellhead pipe 152, manifold 154, and manifold pipes 156. The height of portions of the pipe system 150 can be changed independently by raising or lowering one of the adjustable stands 100 or jointly by through use of all of the adjustable stands 100. In addition the wellhead pipe 152, and manifold pipes 156 can each be individually be raised or lowered adjustable stand. In FIG. 5 the wellhead pipe 152, and manifold pipes 156 are shown at the same height level with the wellhead pipes 156. The manifold pipes 156 curve up and down at the ends of the pipe system 150 to connect to a manifold 154 at each end of the pipe system 150. In FIG. 6 the two manifold pipes 156 are at the same height while the wellhead pipe 152 has been lowered to connect to a vertical section of wellhead pipe. In this manner the adjustable stands 100 can be used accommodate any type of pipe system 150 or terrain.

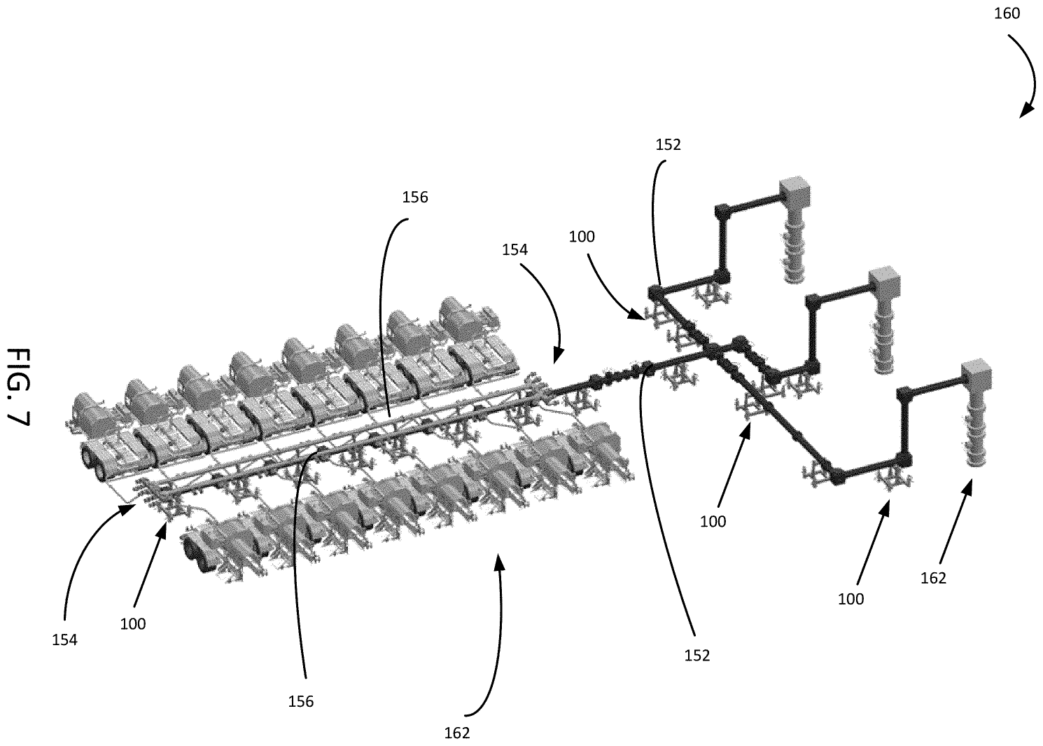

Turning now to FIG. 7, a hydraulic fracturing system 160 is shown. The system includes wellhead pipe 152, manifold pipes 156, manifolds 154, adjustable stands 100, one or more trailers 162, and one or more wellheads 158. The trailers are connected to the manifolds 154 and manifold pipes 156. The manifolds 154 and manifold pipes 156 combine fracturing fluids from the trailer and then the manifold pipes 156 deliver the fluid to the wellhead pipe 152. The wellhead pipe 152 then delivers the fluid to a wellhead 158 in a single stream. As shown in FIG. 7, if there are multiple wellheads 158 connected to the hydraulic fracturing system 160, the wellhead pipe 152 can split the fluid streams so that each wellhead 158 receives a single stream of fracturing fluid from the hydraulic fracturing system 160.

The adjustable stands 100 are used to support the pipes within the hydraulic fracturing system 160. The adjustable stand allows larger and heavier fluid pipe to be used within the hydraulic fracturing system while still allowing the hydraulic fracturing system 160 to accommodate wellsites with various terrains and height requirements. The increased pipe weights and sizes allow the hydraulic fracturing system to deliver the required amounts of fluid for hydraulic fracturing while limiting the amount of wear and tear. The single stream also simplifies the hydraulic fracturing system, which cuts down on injury and damage due to operator error.

It is to be understood that the terms “including”, “comprising”, “consisting” and grammatical variants thereof do not preclude the addition of one or more components, features, steps, or integers or groups thereof and that the terms are to be construed as specifying components, features, steps or integers. If the specification or claims refer to “an additional” element, that does not preclude there being more than one of the additional element. It is to be understood that where the claims or specification refer to “a” or “an” element, such reference is not be construed that there is only one of that element. It is to be understood that where the specification states that a component, feature, structure, or characteristic “may”, “might”, “can” or “could” be included, that particular component, feature, structure, or characteristic is not required to be included.

Thus, the embodiments of the present disclosure are well adapted to carry out the objects and attain the ends and advantages mentioned above as well as those inherent therein. While the inventive device and system have been described and illustrated herein by reference to particular non-limiting embodiments in relation to the drawings attached thereto, various changes and further modifications, apart from those shown or suggested herein, may be made therein by those of ordinary skill in the art, without departing from the spirit of the inventive concepts.

It is claimed:

1. An adjustable stand comprising:
a frame;
one or more legs connected to the frame, wherein the one or more legs extend downward from the frame and comprise:
a support member; and
a telescoping sheath wherein the telescoping sheath can be raised or lowered on the support member;
one or more racks connected to the frame, wherein the one or more racks extend upward from the frame,
one or more clamps comprising a clamp support, wherein one of the one or more clamp supports is attached to one of the one or more racks, and wherein the one or more clamps can be moved up or down on the one or more racks.

2. The adjustable stand of claim 1, wherein the telescoping sheath envelops the support member.

3. The adjustable stand of claim 1, wherein each of the one or more legs further comprise a crank, wherein the telescoping sheath can be raised or lowered on the support member by turning the crank.

4. The adjustable stand of claim 1, wherein the each of the one or more legs further comprise a foot.

5. The adjustable stand of claim 4, wherein the foot further comprises an anchor, for securing the leg to a support surface.

6. The adjustable stand of claim 1, wherein the one or more racks further comprise one or more clamp mounts.

7. The adjustable stand of claim 6, wherein the clamp support is connected to the one or more clamp mounts.

8. The adjustable stand of claim 1, wherein the clamp further comprises a clamp lock for securing objects within the clamp, wherein the clamp lock is removeably attached to the clamp support.

9. The adjustable stand of claim 8, wherein the clamp support is connected to the clamp lock with a hinge. a flange for supporting the connection to the frame.

10. The adjustable stand of claim 1, wherein the one or more racks further comprise one or more flanges, wherein the one or more flanges are connected to the frame and one or more racks.

11. The adjustable stand of claim 1, wherein the one or more clamps can be independently adjusted on the racks.

12. A hydraulic fracturing system comprising:
one or more adjustable stands comprising:
a frame;
one or more legs connected to the frame and extending downward from the frame, wherein the one or more legs comprise:
a support member; and
a telescoping sheath wherein the telescoping sheath can be raised or lowered on the support member;
one or more racks connected to the frame, wherein the one or more racks extend upward from the frame; and
one or more clamps connected to the racks, comprising a clamp support, wherein the clamp support is attached to the rack, and wherein the one or more clamps can be moved up or down on the one or more racks.
one or more manifolds;
a system of manifold pipes connected to the manifolds;
one or more trailers configured to deliver hydraulic fracturing fluid to the one or more manifolds and the system of manifold pipes; and
a wellhead pipe, configured to receive hydraulic fracturing from the one or more manifolds and system of manifold pipes and deliver the hydraulic fracturing fluid to a wellhead;
wherein the one or more adjustable stands support the system of manifold pipes and wellhead pipes, and wherein the one or more adjustable stands can raise or lower the height of the system of manifold pipes and wellhead pipes.

13. The hydraulic fracturing system of claim 1, wherein the system of manifold pipes and wellhead pipes can be independently raised and lowered by the one or more adjustable stands.

14. The adjustable stand of claim 10, wherein the telescoping sheath envelops the support member.

15. The adjustable stand of claim 10, wherein the leg further comprises a crank, wherein the telescoping sheath can be raised or lowered on the support member by turning the crank.

16. The adjustable stand of claim 10, wherein the leg further comprises a foot for supporting the leg.

17. The adjustable stand of claim 14, wherein the foot further comprises an anchor, for securing the leg to a support surface.

18. The adjustable stand of claim 10, wherein the one or more racks further comprise one or more clamp mounts.

19. The adjustable stand of claim 16, wherein the clamp support is connected to the one or more clamp mounts.

20. The adjustable stand of claim 10, wherein the clamp further comprises a clamp lock for securing objects within the clamp, wherein the clamp lock is removeably attached to the clamp support.
